(19) United States
(12) Patent Application Publication
(10) Pub. No.: US 2018/0215854 A1
(43) Pub. Date: Aug. 2, 2018

(54) BONDED PERMANENT MAGNETS PRODUCED BY ADDITIVE MANUFACTURING

(71) Applicants: UT-Battelle, LLC, Oak Ridge, TN (US); Iowa State University Research Foundation, Inc., Ames, IA (US); PPG Industries, Inc., Pittsburgh, PA (US)

(72) Inventors: M. Parans PARANTHAMAN, Knoxville, TN (US); Orlando RIOS, Knoxville, TN (US); William G. CARTER, Oak Ridge, TN (US); David FENN, Allison Park, PA (US); Cajetan Ikenna NLEBEDIM, Ames, IA (US)

(21) Appl. No.: 15/887,490

(22) Filed: Feb. 2, 2018

Related U.S. Application Data
(60) Provisional application No. 62/453,716, filed on Feb. 2, 2017.

(51) Int. Cl. C08G 18/08; C08G 18/34; C08G 18/32; C08G 18/73; C08G 18/75; C08G 18/76; C08G 18/78; C08K 3/08; C08K 3/04; C08K 3/34; C08K 3/36; H01F 41/02; H01F 1/057; B33Y 70/00

(52) U.S. Cl. CPC C08G 18/0838; B29K 2507/04; C08G 18/3234; C08G 18/73; C08G 18/755; C08G 18/7621; C08G 18/7671; C08G 18/7893; C08K 3/08; C08K 3/041; C08K 3/346; C08K 3/36; H01F 41/0253; H01F 1/0578; B33Y 70/00; C08G 2140/00; C08K 2003/0856; C08K 2201/01; C08K 2201/011; C08G 18/346

(57) ABSTRACT

A method for producing a bonded permanent magnet by additive manufacturing, the method comprising: (i) incorporating components of a reactive precursor material into an additive manufacturing device, the reactive precursor material comprising an amine component, an isocyanate component, and particles having a permanent magnetic composition; and (ii) mixing and extruding the crosslinkable reactive precursor material through a nozzle of the additive manufacturing device and depositing the extrudate onto a substrate under conditions where the extrudate is permitted to cure, to produce a bonded permanent magnet of desired shape. The resulting bonded permanent magnet and articles made thereof are also described.

### CROSS REFERENCE TO RELATED APPLICATION

The present application claims benefit of U.S. Provisional Application No. 62/453,716, filed on Feb. 2, 2017, all of the contents of which are incorporated herein by reference.

### STATEMENT REGARDING FEDERALLY SPONSORED RESEARCH

This invention was made with government support under Prime Contract Nos. DE-AC05-00OR22725 and AC02-07CH11358 awarded by the U.S. Department of Energy. The government has certain rights in the invention.

### FIELD OF THE INVENTION

The present invention relates generally to bonded permanent magnets and methods for producing them. The invention also relates to additive manufacturing methods, such as 3-D printing, fused deposition modeling (FDM), and fused filament fabrication (FFF).

### BACKGROUND OF THE INVENTION

The growth in compact electronic devices has resulted in the need to develop net-shape high performance permanent magnets with minimal post-fabrication machining. Machining of sintered Nd—Fe—B magnets adds to manufacturing costs and results in significant waste of materials in the form of grinding or cutting swarfs. In contrast, bonded magnets can easily be made into desired shapes with minimal or no post-manufacturing machining. As a result, bonded magnets are suitable for applications in which post-manufacturing processing limits the use of sintered magnets and are, therefore, well suited for advanced manufacturing technologies. Bonded magnets are typically manufactured by mixing magnetic powders with a binder of choice, pouring the mixture into a mold and subjecting it to a hardening (curing) process. Bonded magnets can be made in both rigid and flexible forms, thereby making them suitable for many applications. The binders used for making bonded magnets can, in some cases, be used to improve mechanical properties and corrosion resistance, increase resisitivity and reduce eddy current loss. In addition, bonded magnets can help address criticality in materials for developing high performance rare-earth based permanent magnets by minimizing post-manufacturing processing wastes while using smaller quantities of magnetic materials, compared to sintered magnets.

Nevertheless, there are some problems being encountered with bonded magnets produced by current processes. The dilution of the magnetic properties of the magnet powder in non-magnetic media, such as polymer binders, results in low energy (BH)ₘₐₓ products. Commercially available bonded Nd—Fe—B magnets typically have (BH)ₘₐₓ of 10-12 MGOe. The achievable (BH)ₘₐₓ depends on the magnetic properties of the magnet powders and the loading fraction in the binder, assuming that the manufacturing process does not deteriorate the properties of the powder. The loading fraction, in turn, depends on the molding process selected. Moreover, in some applications, manufacturability, mechanical properties, and the ability to withstand corrosive environments, may be more limiting than high (BH)ₘₐₓ.

Conventional methods for producing bonded magnets employ such polymers as nylon, ABS, polyphenylene sulfide (PPS), and polyether ether ketone (PEEK). The foregoing materials are the status quo in polymer additive manufacturing. However, there are several limitations associated with thermal-based deposition systems using these conventional polymers, including complexity in thermal control, part distortion, and weak layer-to-layer strength. In traditional polymer extrusion-based systems, the feed material is simply melted and extruded directly onto a cold or warm plate or prior build layer. Although simple in design, the conventional method requires materials that are spatially locked in place immediately after deposition, maintain tolerance during subsequent thermal cycling, and form a strong mechanical bond to subsequent layers. The mechanical strength of a thermoplastic typically increases with the molecular weight and degree of branching or side chains. Unfortunately, this also results in an elevation of the melt viscosity and melting point. The z-strength or mechanical properties of the bond between adjacent layers is formed by physically pushing the polymer melt into the previous layer. Therefore, the resistance to melt flow is an important parameter, and the extrusion of high strength thermoplastics requires elevated temperatures, but this tends to increase thermal distortion. Thus, there would be a significant benefit in a polymer binder that could provide an optimal balance in reaction time, curing time, and mechanical strength so as to provide a permanent bonded magnet with improved layer-to-layer strength and overall integrity along with high magnet powder loading.

### SUMMARY OF THE INVENTION

The present disclosure is directed to methods for producing permanent bonded magnets of any of a variety of shapes and with exceptional mechanical and magnetic field strengths. Significantly, the methods described herein do not rely on high molecular weight or crosslinked thermoplastic polymer binders, coupled with sufficiently high temperature to induce melt flow, as generally employed in the art, as the means for producing permanent bonded magnets. The methods described herein include the following steps: (i) incorporating components of a reactive precursor material into an additive manufacturing device, the reactive precursor material containing an amine component, an isocyanate component, and particles having a permanent magnetic composition; and (ii) mixing and extruding the reactive precursor material through a nozzle of the additive manufacturing device and depositing the extrudate onto a substrate under conditions where the extrudate is permitted to cure, to produce a bonded permanent magnet of desired shape.

In particular embodiments, the amine component is or includes an amine-containing molecule selected from at least one of the following structures:

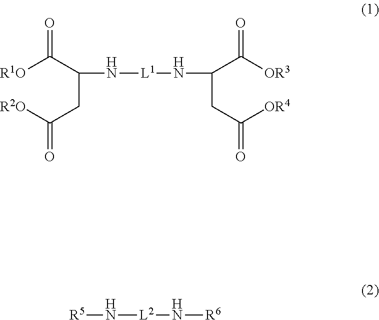

wherein: L¹ is a straight-chained or branched alkyl linker containing at least four and up to twelve carbon atoms; R¹, R², R³, and R⁴ are selected from alkyl groups containing one to three or four carbon atoms; L² is a linker containing at least one saturated carbocyclic ring; and R⁵ and R⁶ are selected from alkyl groups containing three to eight carbon atoms.

In the method disclosed herein, the viscosity of the precursors and reaction kinetics were tuned to achieve staged in situ crosslinking that permitted the development of a novel high-throughput deposition method that is highly scalable, compatible with high loading of reinforcing agents, such as carbon/glass fibers, yet is inherently low-cost. The disclosed method advantageously achieves a (fast set)-(slow cure) deposition in which reactive components cross-link shortly after deposition yet continue to react for several hours. The staged in situ crosslinking deposition method, as outlined in FIGS. 1A, 1B, and 1C, results in an additively manufactured build that has sufficient mechanical properties to bear the load of additional layers, yet is sufficiently unreacted to permit formation of extensive chemical crosslinking networks across z-layers. FIGS. 2A and 2B outline the stages, including multi-stage reaction kinetics, associated with the novel deposition methods of the present method. Site-specific deposition of the viscosity stabilized reactive mixture forms the initial build layers. The reactive materials partially crosslink over a period of two seconds to over thirty minutes, which further spatially locks the deposited material. Since earlier deposited layers are not fully reacted, subsequent layers will form a chemical bond with the underlying deposit. FIGS. 2A and 2B show how the reaction front moves up the build across the z-layers. The velocity of the reaction front is directly dependent on the reactivity of the deposited mixture, build temperature, and deposition temperature.

Thermoset polymers typically outperform thermoplastics in a number of critical areas, including mechanical properties (such as elastic modulus), chemical resistance, thermal stability, and overall durability. Thermosets, like thermoplastics, can also be used in composite structures and can attain higher performance properties when used with structural reinforcements. Polyurea, as used in the present disclosure, may be derived from starting materials having a wide range of rheological properties and tunable reaction kinetics, features which can be used to accelerate deposition rates. Polyurea also has an advantage in deposition temperatures, relative to typical thermoplastics, which typically require melting. The low temperature deposition and curing reactions of the presently disclosed process often only require ambient conditions, which ultimately helps to minimize component distortion.

### BRIEF DESCRIPTION OF THE FIGURES

FIGS. 1A-1C. FIG. 1A graphically depicts the stages (partial and full curing) involved in the in-situ crosslinking deposition method of the present invention. FIG. 1B schematically depicts the same stages shown in FIG. 1A. FIG. 1C exhibits the steps involved in the inventive deposition process.

FIGS. 2A-2B. FIG. 2A graphically depicts the gel stage, partially crosslinked stage, and mostly crosslinked stage involved in the in-situ crosslinking deposition method of the present invention. FIG. 2B shows the evolution and changing contributions of the different stages shown in FIG. 2A over time.

FIGS. 3A-3C. FIGS. 3A, 3B, and 3C show the results of a drop flow test in graph format for a series of amine-isocyanate combinations, for 10, 15, and 20 seconds of mixing, respectively, for FIGS. 3A, 3B, and 3C.

FIG. 4. Representation of a set-up for a bead-forming experiment used for simulating an additive manufacturing process.

FIGS. 5A-5B. Hysteresis loops of bonded magnet samples produced from B2 (FIG. 5A) and C2 (FIG. 5B) isocyanate-amine polyurea binder compositions loaded with 40 vol % MQA magnetic powder, measured in both parallel and perpendicular directions. Note: the term “B2” indicates presence (combination) of amine B and isocyanate 2, and the term “C2” indicates presence (combination) of amine C and isocyanate 2. The identities of these amines and isocyanates are indicated in Tables 1 and 2 and in succeeding paragraphs.

FIG. 6. Graph comparing magnetic properties of B2, C2, and C4 isocyanate-amine polyurea binder compositions, and separately, ethyl vinyl acetate (EVA) matrix, all loaded with 40 vol % MQA magnetic powder.

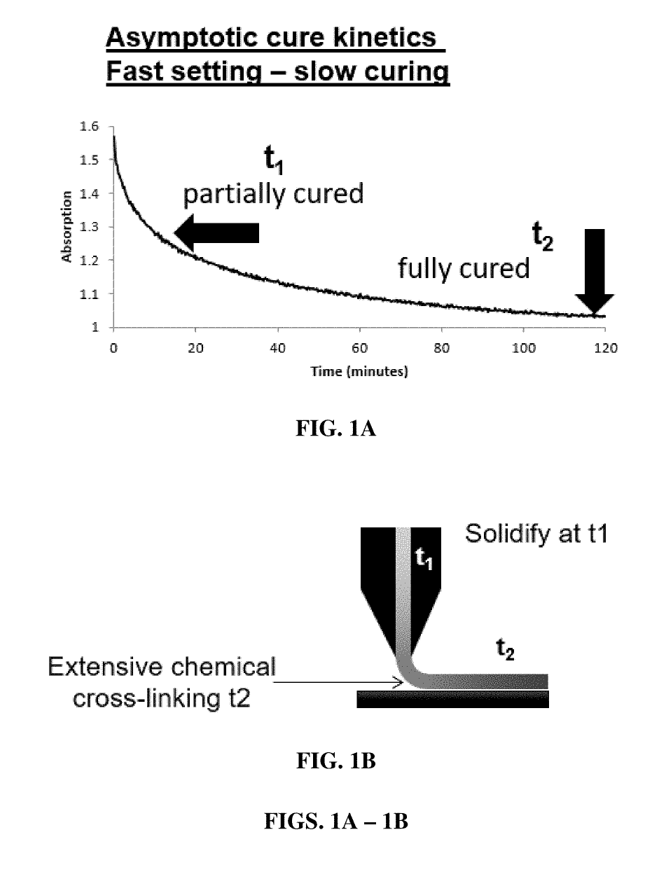

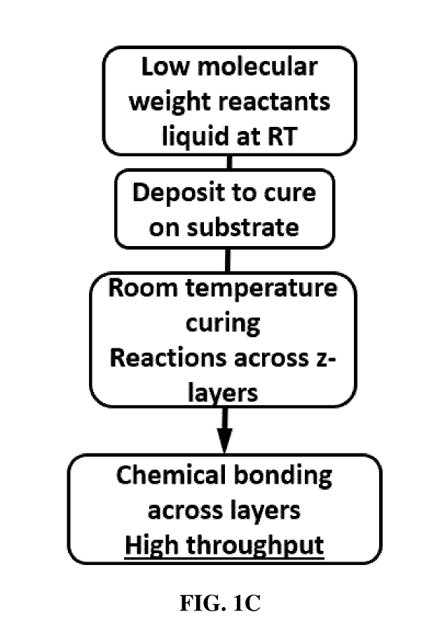

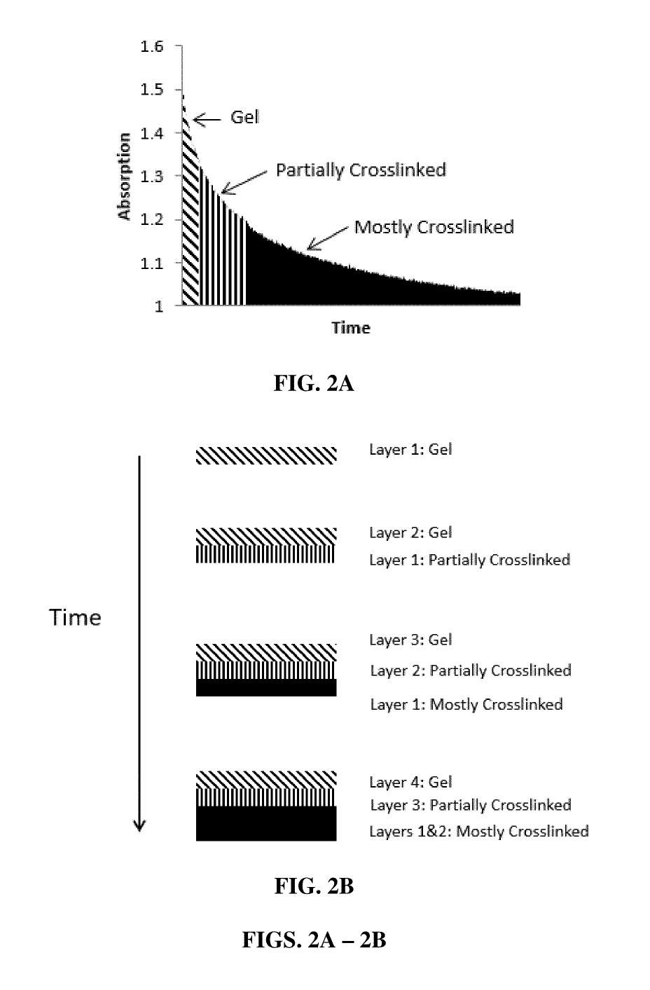

### DETAILED DESCRIPTION OF THE INVENTION

In the presently disclosed process, a reactive precursor material containing components for producing a polyurea binder (i.e., amine and isocyanate components) and particles having a permanent (i.e., hard) magnetic composition is fed into an additive manufacturing device to produce a bonded permanent magnet. The reactive precursor material employed herein possesses the unique characteristic of quickly setting within a few seconds, yet taking a longer time to fully cure, thereby establishing better bonding and cohesive strength between layers during the deposition process.

The additive manufacturing process can be any of the additive processes well known in the art, such as a rapid prototyping unit, such as a fused deposition modeling (FFF) device, or more particularly, a 3D printer. As well known in the art, the additive process generally operates by mixing and extruding a composite through a die or nozzle of a suitable shape and repeatedly depositing discrete amounts (e.g., beads) of the composite material in designated locations to build a structure. Although many additive processes employ an elevated temperature to form an extrudate, the reactive precursor material described herein is typically extruded at ambient temperature without additional heating (generally, 15-30° C. or about 25° C.). Indeed, at least one or both of the amine and isocyanate components are typically in the liquid state under ambient conditions, and the reaction is typically exothermic. Upon exiting the die (i.e., nozzle) in the additive processing unit, the composite extrudate cools, cures, and solidifies. In the FFF or 3D printing process, the nozzle is moved in precise horizontal and vertical positions as beads of the composite are deposited. The beads of composite are sequentially deposited to build a magnetic object, layer by layer. The nozzle movements and flow rate of the composite are generally controlled by computer software, typically a computer-aided manufacturing (CAM) software package. The FFF or 3D printer builds an object (article) based on instructions provided by a computer program that includes precise specifications of the object to be constructed.

In some embodiments, the additive manufacturing process is a big area additive manufacturing (BAAM) process. As well known in the art, the BAAM process employs an unbounded open-air build space in which at least one, and typically, a multiplicity, of deposition heads controlled by one or a multiplicity of multi-axis robotic arms operate in concert to construct an object. In the BAAM process, the feed material is processed within and ultimately deposited from the deposition head layer-by-layer as an extrudate, which cools over time to produce the bonded permanent magnet. The BAAM process considered herein may use only the reactive precursor material as feed for the entire BAAM process, or the BAAM process may employ the reactive precursor material as feed in one or more deposition heads and may employ another (non-magnetic) feed in one or more other deposition heads to construct an object with magnetic and non-magnetic portions. As well known, the deposition head in a BAAM process is designed to combine melting, compounding, and extruding functions to produce and deposit an extrudate of the precursor material layer-by-layer. The deposition heads are moved and precisely positioned by the multi-axis robotic arm, which can be either stationary or mounted on a multi-axis or conventional three-axis gantry system. The multi-axis robotic arms are, in turn, instructed by a computer program, as generally provided by a computer-aided manufacturing (CAM) software package. As also well known, in the BAAM process, one deposition head may be partly or solely responsible for building a specific region of the overall object, but generally coordinates with at least one other deposition head, which is involved in building another region of the overall object. The BAAM process is described in detail in, for example, C. Holshouser et al., Advanced Materials & Processes, 15-17, March 2013, and M. R. Talgani et al., SAMPE Journal, 51(4), 27-36, July/August 2015, the contents of which are herein incorporated by reference in their entirety.

The shape of the object that is ultimately built can be suited to any application in which a magnetic material having a significant degree of mechanical strength is desired, such as electrical motors. Although the shape of the magnetic material ultimately produced can be simple, e.g., a planar object, such as a film or coating of a desired two-dimensional shape (e.g., square or disc), the additive manufacturing process is primarily suited to the production of complex (i.e., intricate) shapes. Some examples of intricate shapes include rings, filled or unfilled tubes, filled or unfilled polygonal shapes having at least or more than four vertices, gears, and irregular (asymmetric) shapes. Other possible shapes include arcs with an angle greater than 90 degrees and less than 180 degrees, preferably in the range of 120-160 degrees.

The amine component should include at least two primary and/or secondary amino groups per amino-containing molecule. The amine component can be or include any of the diamine or polyamine compounds know in the art. In particular embodiments, the amine component is or includes an aspartic ester amine, such as any of those types of amines described in U.S. Pat. No. 7,342,056, WO2016/085992, or WO2016/085914, the contents of which are herein incorporated by reference. The aspartic ester amine may have the following structure:

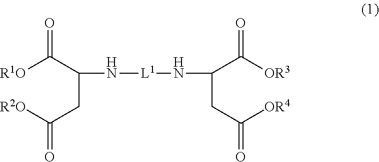

In Formula (1) above, L¹ may be a divalent hydrocarbon group (divalent linker) having 1 to 20 carbon atoms. In different embodiments, the divalent hydrocarbon group may have at least 1, 2, 3, or 4 carbon atoms and up to 5, 6, 7, 8, 9, 10, 11, 12, 15, 18, or 20 carbon atoms. The divalent hydrocarbon group may be straight-chained, branched, or cyclic; aliphatic or aromatic; and/or saturated or unsaturated, or have a combination of these features (e.g., a cyclic group connected to straight-chained or branched linking groups, such as -cyclohexyl-CH₂-cyclohexyl- or —CH₂CH₂-cyclohexyl-CH₂CH₂—). In some embodiments, L¹ may be a straight-chained or branched alkyl or alkenyl linker containing a number of carbon atoms as described above. The straight-chained alkyl linker can be conveniently depicted by the following formula: —(CH₂)ₙ—, wherein n is an integer of 1-20, e.g., at least 1, 2, 3, or 4 carbon atoms and up to 5, 6, 7, 8, 9, 10, 11, 12, 15, 18, or 20. The straight-chained alkenyl linker can have a structure corresponding to —(CH₂)ₙ—, except that at least one carbon-carbon double bond has been incorporated (along with removal of two adjacent hydrogen atoms), e.g., —CH₂CH₂—CH═CH—CH₂CH₂— or —CH═CH₂—CH₂—CH═CH— or —CH═CH₂-cyclohexyl-CH═CH—. The branched alkyl or alkenyl linkers can have a structure corresponding to —(CH₂)ₙ—, except that at least one of the shown hydrogen atoms has been replaced with a hydrocarbon group containing 1 to 6 carbon atoms, such as a methyl, ethyl, n-propyl, isopropyl, vinyl, allyl, cyclopropyl, cyclobutyl, cyclopentyl, cyclohexyl, or phenyl group. Some examples of branched alkyl groups include —CH₂CH₂CH₂CH(CH₃)CH₂—, —CH₂CH₂CH₂CH(CH₃)CH₂CH₂—, —CH₂CH₂CH(CH₃)CH(CH₃)CH₂CH₂—, and —CH₂CH(CH₃)-cyclohexyl-CH(CH₃)CH₂—. In some embodiments, L¹ is or includes at least one cyclic hydrocarbon group, which may be aliphatic or aromatic, or alternatively, saturated (cycloalkyl) or unsaturated (cycloalkenyl). The term “cyclic hydrocarbon group” often refers to a monocyclic ring (such as a three-, four-, five-, six-, or seven-membered ring), but also includes the possibility of bicyclic rings. Some examples of cycloalkyl groups include cyclopropyl, cyclobutyl, cyclopentyl, cyclohexyl, decalinyl, and bicyclohexyl rings. Some examples of aliphatic hydrocarbon groups include the foregoing alkyl, alkenyl, and cycloalkyl groups and, for example, cyclopentenyl, cyclohexenyl, and cyclohexadienyl rings. A primary example of an aromatic hydrocarbon linker is phenylene. The cyclic hydrocarbon group may or may not be substituted with one or more alkyl groups, typically containing 1-3 carbon atoms, such as methyl, ethyl, n-propyl, or isopropyl groups.

In Formula (1), R¹, R², R³, and R⁴ are independently selected from straight-chained or branched alkyl or alkenyl groups and/or from saturated or unsaturated cyclic hydrocarbon groups. The foregoing groups typically contain 1, 2, 3, 4, 5, or 6 carbon atoms, or a number of carbon atoms within a range bounded by any two of the foregoing values. Some examples of alkyl groups include methyl, ethyl, n-propyl, isopropyl, n-butyl, isobutyl, sec-butyl, t-butyl, n-pentyl, isopentyl, neopentyl, n-hexyl, and isohexyl. Some examples of alkenyl groups include vinyl, allyl, 2-buten-1-yl, and 2-buten-3-methyl-1-yl. Examples of cyclic hydrocarbon groups have been given above.

In particular embodiments, the amine-containing molecule according to Formula (1) may have any of the following specific structures:

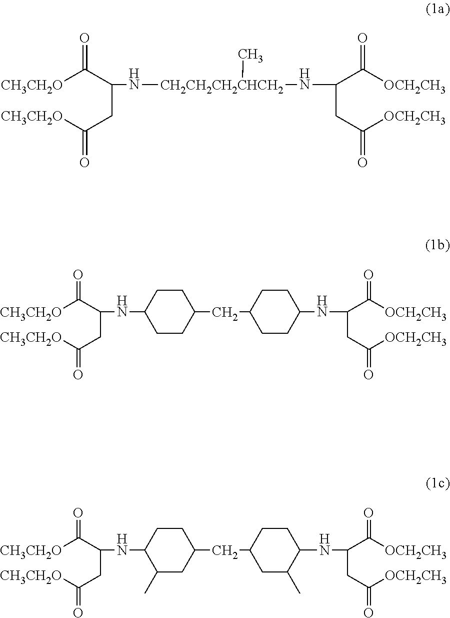

In some embodiments, any one or more of the shown ethyl groups may be replaced with another hydrocarbon group as described above, such as, for example, methyl, n-propyl, isopropyl, n-butyl, isobutyl, sec-butyl, t-butyl, n-pentyl, isopentyl, neopentyl, n-hexyl, isohexyl, cyclopropyl, cyclobutyl, cyclopentyl, cyclohexyl, decalinyl, bicyclohexyl, cyclopentenyl, cyclohexenyl, cyclohexadienyl, and phenyl.

In other particular embodiments, the amine-containing molecule may have the following structure:

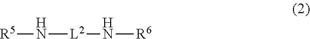

In Formula (2) above, L² is a linker containing (i.e., is or includes) at least one saturated carbocyclic ring. Some examples of cycloalkyl rings include cyclopropyl, cyclobutyl, cyclopentyl, cyclohexyl, decalinyl, and bicyclohexyl rings. The groups R⁵ and R⁶ are selected from straight-chained or branched alkyl or alkenyl groups and/or from saturated or unsaturated cyclic hydrocarbon groups. The foregoing groups for R⁵ and R⁶ typically contain 3, 4, 5, 6, 7, or 8 carbon atoms, or a number of carbon atoms within a range bounded by any two of the foregoing values. Some examples of alkyl groups include methyl, ethyl, n-propyl, isopropyl, n-butyl, isobutyl, sec-butyl, t-butyl, n-pentyl, isopentyl, neopentyl, n-hexyl, isohexyl, n-heptyl, isoheptyl, n-octyl, and isooctyl. Some examples of alkenyl groups include vinyl, allyl, 2-buten-1-yl, 2-buten-3-methyl-1-yl, and 3-hexen-3,4-dimethyl-1-yl. Examples of cyclic hydrocarbon groups have been given above.

In particular embodiments, the amine-containing molecule according to Formula (2) may have the following specific structure:

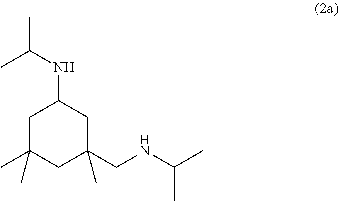 [SMILES: CC(C)NCC1(C)CC(NC(C)C)CC(C)(C)C1]

The isocyanate component can be any of the isocyanate-containing compounds known in the art containing at least or precisely two, three, or four isocyanate groups. The isocyanate compound may be aliphatic or aromatic, wherein the term “aliphatic” or “aromatic” refers to the group linking the isocyanate (—NCO) functional groups. An aliphatic isocyanate compound may be saturated or unsaturated (i.e., the group linking the isocyanate groups may be saturated or unsaturated). Some well-known examples of aliphatic isocyanate compounds include hexamethylene diisocyanate (HDI), isophorone diisocyanate (IPDI), cyclohexane-1,4-diisocyanate, and 1,1′-methylene-bis(4-isocyanatocyclohexane). Some well-known examples of aromatic isocyanate compounds include toluene diisocyanate (TDI), methylene diphenyl diisocyanate (MDI), p-phenylene diisocyanate (PPDI), and naphthalene diisocyanate (NDI). In some embodiments, the isocyanate is an alkylene triisocyanate, such as 4-isocyanatomethyl-1,8-octamethylene diisocyanate of the formula OCN—(CH₂)₃—CH(CH₂—NCO)—(CH₂)₄—NCO, as described in U.S. Pat. No. 4,314,048, the contents of which are herein incorporated by reference.

In some embodiments, the isocyanate component is or includes at least one isocyanate-containing molecule containing an isocyanurate ring. These types of isocyanate molecules are described in, for example, U.S. Pat. Nos. 4,491,663, 4,801,663, and 9,464,160, the contents of which are herein incorporated by reference in their entirety. In exemplary embodiments, the isocyanate-containing molecule has the following structure:

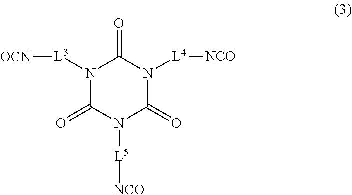

wherein L³, L⁴, and L⁵ are independently selected from straight-chained, branched, and cyclic alkyl linkers containing at least four and up to twelve carbon atoms, all of which have been described under Formula (1) above. In different embodiments, L³, L⁴, and L⁵ are independently selected from straight-chained and branched alkyl linkers independently (or all simultaneously) containing, for example, 4, 5, 6, 7, 8, 9, 10, 11, or 12 carbons or a number of carbon atoms within a range bounded by any two of the foregoing values. In some embodiments, L³, L⁴, and L⁵ are all the same, while in other embodiments L³, L⁴, and L⁵ are different.

In some embodiments, the isocyanate contains four isocyanate groups, such as, for example, tetraisocyanatosilane (CAS 3410-77-3), 4,4′-benzylidenebis(6-methyl-m-phenylene) tetraisocyanate (CAS 28886-07-9), (benzene,1,1′-(phenylmethylene)bis[2,4-diisocyanato-5-methyl-) (CAS 28886-07-9), and the numerous triphenylmethane tetraisocyanate derivatives known in the art, as described in U.S. Pat. Nos. 3,707,486 and 3,763,110, the numerous methylene-bridged aromatic tetraisocyanate compositions described in U.S. Pat. No. 3,904,666, as well as those described in U.S. Pat. No. 3,763,110, the contents of which are herein incorporated by reference in their entirety.

The particles having a permanent (hard) magnetic composition (i.e., “magnetic particles”) can have any suitable particle size, but typically no more than or less than 1 mm, 0.5 mm, 200 microns, 100 microns, 50 microns, 1 micron, 0.5 micron, 0.2 micron, or 0.1 micron, or a distribution of particles bounded by any two of these values. The magnetic particles can be, for example, nanoparticles (e.g., 1-500 nm) or microparticles (e.g., 1-500 microns). The term “permanent magnetic composition” refers to any of the ferromagnetic or ferrimagnetic compositions, known in the art, that exhibit a permanent magnetic field with high coercivity, generally at least or above 300, 400, or 500 Oe. Thus, the magnetic particles considered herein are not paramagnetic or superparamagnetic particles. The magnetic particles may be magnetically isotropic or anisotropic, and may have any desired shape, e.g., substantially spherical, ovoid, filamentous, or plate-like. The magnetic particles typically have an anisotropic coercive property.

Typically, the permanent magnetic composition is metallic or a metal oxide, and often contains at least one element selected from iron, cobalt, nickel, copper, gallium, and rare earth elements, wherein the rare earth elements are generally understood to be any of the fifteen lanthanide elements along with scandium and yttrium. The permanent magnet may also or alternatively include one or more refractory metals, e.g., titanium, vanadium, zirconium, and hafnium, or an alloy of a refractory metal with carbon, e.g., titanium carbide. In particular embodiments, the permanent magnetic composition includes iron, such as magnetite, lodestone, or alnico. In other particular embodiments, the permanent magnetic composition contains at least one rare earth element, particularly samarium, praseodymium, and/or neodymium. A particularly well-known samarium-based permanent magnet is the samarium-cobalt (Sm—Co alloy) type of magnet, e.g., SmCo₅ and Sm₂Co₁₇. A particularly well-known neodymium-based permanent magnet is the neodymium-iron-boron (Nd—Fe—B) type of magnet, typically having the formula Nd₂Fe₁₄B. Other rare earth-containing magnetic compositions include, for example, Pr₂Co₁₄B, Pr₂Fe₁₄B, and Sm—Fe—N(e.g., Sm₂Fe₁₇Nₓ powders). The hard magnet material may or may not have a composition that excludes a rare earth metal. Some examples of non-rare earth hard magnetic materials include MnBi, AlNiCo, Fe₁₆N₂, and ferrite-type compositions, such as those having a Ba—Fe—O or Sr—Fe—O composition. Particle versions of such magnetic compositions are either commercially available or can be produced by well-known procedures, as evidenced by, for example, P. K. Deheri et al., “Sol-Gel Based Chemical Synthesis of Nd₂Fe₁₄B Hard Magnetic Nanoparticles,” Chem. Mater., 22 (24), pp. 6509-6517 (2010); L. Y. Zhu et al., “Microstructural Improvement of NdFeB Magnetic Powders by the Zn Vapor Sorption Treatment,” Materials Transactions, vol. 43, no. 11, pp. 2673-2677 (2002); A. Kirkeminde et al., “Metal-Redox Synthesis of MnBi Hard Magnetic Nanoparticles,” Chem. Mater., 27 (13), p. 4677-4681 (2015); and U.S. Pat. No. 4,664,723 (“Samarium-cobalt type magnet powder for resin magnet”). The permanent magnetic composition may also be a rare-earth-free type of magnetic composition, such as a Hf—Co or Zr—Co alloy type of permanent magnet, such as described in Balamurugan et al., Journal of Physics: Condensed Matter, vol. 26, no. 6, 2014, the contents of which are herein incorporated by reference in their entirety. In some embodiments, any one or more of the above-described types of magnetic particles are excluded from the precursor material and resulting bonded permanent magnet produced after additive manufacturing.

The magnetic particles are generally included in the reactive precursor material in an amount of at least or above 20 wt. % by weight of the polymer binder and magnetic particles (or alternatively, by weight of the entire reactive precursor material). In different embodiments, the magnetic particles are included in an amount of at least or above 20, 30, 40, 50, 60, 70, 80, 90, 92, 95, or 98 wt. %, or in an amount within a range bounded by any two of the foregoing values.

In some embodiments, the reactive precursor material further includes non-magnetic solid filler material (e.g., particles) having a composition that increases the viscosity of the reactive precursor material and confers additional tensile strength to the bonded magnetic after curing. The non-magnetic filler material (e.g., particles) can be composed of, for example, carbon, metal oxide, or metal carbon particles. The particles may have any suitable morphology, including, for example, spheroidal particles or filaments. The filler material (e.g., particles) may be present in the reactive precursor material in any desired amount, e.g., at least or above 1, 2, 5, 10, 20, 30, 40, or 50 wt. %, or in an amount within a range bounded by any two of the foregoing values. The term “filament,” as used herein, refers to a particle having a length dimension at least ten times its width dimension, which corresponds to an aspect ratio (i.e., length over width) of at least or above 10:1 (i.e., an aspect ratio of at least 10). In different embodiments, the filament has an aspect ratio of at least or above 10, 20, 50, 100, 250, 500, 1000, or 5000. In some embodiments, the term “filament” refers only to particles having one dimension at least ten times greater than the other two dimensions. In other embodiments, the term “filament” also includes particles having two of its dimensions at least ten times greater than the remaining dimension, which corresponds to a platelet morphology. Notably, the magnetic particles may also have a spheroidal, platelet, or elongated (e.g., filamentous) morphology. In some embodiments, the magnetic particles are filaments having any of the aspect ratios described above. Notably, magnetic particles having an anisotropic (e.g., elongated or filamentous) shape are generally more amenable to alignment in a directional magnetic field.

In particular embodiments, carbon filaments are included in the reactive precursor material. The carbon filaments can be, for example, carbon fibers, carbon nanotubes, platelet nanofibers, graphene nanoribbons, or a mixture thereof. In the case of carbon fibers, these may be any of the high-strength carbon fiber compositions known in the art. Some examples of carbon fiber compositions include those produced by the pyrolysis of polyacrylonitrile (PAN), viscose, rayon, lignin, pitch, or polyolefin. The carbon nanofibers may also be vapor grown carbon nanofibers. The carbon fibers can be micron-sized carbon fibers, generally having inner or outer diameters of 1-20 microns or sub-range therein, or carbon nanofibers, generally having inner or outer diameters of 10-1000 nm or sub-range therein. In the case of carbon nanotubes, these may be any of the single-walled or multi-walled carbon nanotubes known in the art, any of which may or may not be heteroatom-doped, such as with nitrogen, boron, oxygen, sulfur, or phosphorus. The carbon filament, particularly the carbon fiber, may possess a high tensile strength, such as at least 500, 1000, 2000, 3000, 5000, or 10,000 MPa. In some embodiments, the carbon filament, particularly the carbon fiber, possesses a degree of stiffness of the order of steel or higher (e.g., 100-1000 GPa) and/or an elastic modulus of at least 50 Mpsi or 100 Mpsi.

In other embodiments, metal oxide filaments are included in the reactive precursor material. The metal oxide filaments (also known as metal oxide nanowires, nanotubes, nanofibers, or nanorods), if present, can be, for example, those having or including a main group metal oxide composition, wherein the main group metal is generally selected from Groups 13 and 14 of the Periodic Table. Some examples of Group 13 oxides include aluminum oxide, gallium oxide, indium oxide, and combinations thereof. Some examples of Group 14 oxides include silicon oxide (e.g., glass), germanium oxide, tin oxide, and combinations thereof. The main group metal oxide may also include a combination of Group 13 and Group 14 metals, as in indium tin oxide. In other embodiments, the metal oxide filaments have or include a transition metal oxide composition, wherein the transition metal is generally selected from Groups 3-12 of the Periodic Table. Some examples of transition metal oxides include scandium oxide, yttrium oxide, titanium oxide, zirconium oxide, hafnium oxide, vanadium oxide, niobium oxide, tantalum oxide, chromium oxide, molybdenum oxide, tungsten oxide, manganese oxide, iron oxide, ruthenium oxide, cobalt oxide, rhodium oxide, iridium oxide, nickel oxide, palladium oxide, copper oxide, zinc oxide, and combinations thereof. The metal oxide filament may also include a combination of main group and transition metals. The metal oxide filament may also include one or more alkali or alkaline earth metals in addition to a main group or transition metal, as in the case of some perovskite nanowires, such as CaTiO₃, BaTiO₃, SrTiO₃, and LiNbO₃ nanowires, and as further described in X. Zhu, et al., J. Nanosci. Nanotechnol., 10(7), pp. 4109-4123, July 2010, and R. Grange, et al., Appl. Phys. Lett., 95, 143105 (2009), the contents of which are herein incorporated by reference. The metal oxide filament may also have a spinel composition, as in Zn₂TiO₄ spinel nanowires, as described in Y. Yang et al., Advanced Materials, vol. 19, no. 14, pp. 1839-1844, July 2007, the contents of which are herein incorporated by reference. In some embodiments, the metal oxide filaments are constructed solely of metal oxide, whereas in other embodiments, the metal oxide filaments are constructed of a coating of a metal oxide on a non-metal oxide filament, e.g., silica-coated or germanium oxide-coated carbon nanotubes, as described in M. Pumera, et al., Chem Asian J., 4(5), pp. 662-667, May 2009, and M. Pumera, et al., Nanotechnology, 20(42), 425606, 2009, respectively, the contents of which are herein incorporated by reference. The metal oxide layer may alternatively be disposed on the surface of a metallic filament. The metal oxide filaments may also have any of the lengths and diameters described above. In other embodiments, the metal oxide material is composed of particles of silica, alumina, aluminosilicate, or clay.

In other embodiments, metal filaments are included in the reactive precursor material. The metal filaments (also known as metal nanowires, nanotubes, nanofibers, or nanorods), if present, can be, for example, those having or including a main group metal composition, such as a silicon, germanium, or aluminum composition, all of which are well known in the art. The metal filaments can also have a composition having or including one or more transition metals, such as nickel, cobalt, copper, gold, palladium, or platinum nanowires, as well known in the art. The metal filaments may also be doped with one or more non-metal dopant species, such as nitrogen, phosphorus, arsenic, or silicon to result in a metal nitride, metal phosphide, metal arsenide, or metal silicide composition. Many of these doped metal compositions are known to have semiconductive properties.

The reactive precursor material may also include an anti-oxidant compound. The anti-oxidant is generally of such composition and included in such amount as to help protect the magnetic particles from oxidizing during the additive manufacturing process. In some embodiments, the anti-oxidant is a phenolic compound, such as phenol or a substituted phenol (e.g., 2,6-di-t-butyl-4-methylphenol). In other embodiments, the anti-oxidant is a complexant molecule, such as EDTA. The anti-oxidant is typically included in the reactive precursor material in an additive amount, typically up to or less than 5, 2, or 1 wt. %.

The reactive precursor material is generally prepared by mixing the polymeric components (i.e., amine and isocyanate components, which are typically liquids) while in a flowable form with magnetic particles by any of the means known in the art for homogeneous mixing of a liquid and solid components. The mixing process may be manual, or may employ, for example, an axial-flow or radial-flow impeller or other mixing device capable of producing a homogeneous blend. The mixing may also occur within the additive manufacturing device, by means of a mixing device included in the additive manufacturing device.

In some embodiments, the precursor includes only the polymer and magnetic particles in the absence of other components. In other embodiments, the reactive precursor material includes one or more additional components that desirably modulate the physical properties of the resulting melt. The reactive material may include, for example, a non-magnetic filler material, as described above. In some embodiments, a plasticizer is included in the precursor material, typically to promote plasticity (i.e., fluidity) and to inhibit melt-fracture during the extrusion and deposition process. The one or more plasticizers included in the precursor material can be any of the plasticizers well known in the art and appropriate for the particular polymer being extruded. For example, in a first embodiment, the plasticizer may be a carboxy ester compound (i.e., an esterified form of a carboxylic or polycarboxylic acid), such as an ester based on succinic acid, glutaric acid, adipic acid, terephthalic acid, sebacic acid, maleic, dibenzoic acid, phthalic acid, citric acid, and trimellitic acid. In a second embodiment, the plasticizer may be an ester-, amide-, or ether-containing oligomer, such as an oligomer of caprolactam, wherein the oligomer typically contains up to or less than 10 or 5 units. In a third embodiment, the plasticizer may be a polyol (e.g., a diol, triol, or tetrol), such as ethylene glycol, diethylene glycol, triethylene glycol, glycerol, or resorcinol. In a fourth embodiment, the plasticizer may be a sulfonamide compound, such as N-butylbenzenesulfonamide, N-ethyltoluenesulfonamide, or N-(2-hydroxypropyl)benzenesulfonamide. In a fifth embodiment, the plasticizer may be an organophosphate compound, such as tributyl phosphate or tricresyl phosphate. In a sixth embodiment, the plasticizer may be an organic solvent. The organic solvent considered herein is a compound that helps to soften or dissolve the polymer and is a liquid at room temperature (i.e., a melting point of no more than about 10, 20, 25, or 30° C.). Depending on the type of polymer, the organic solvent may be, for example, any of those mentioned above (e.g., ethylene glycol or glycerol), or, for example, a hydrocarbon (e.g., toluene), ketone (e.g., acetone or butanone), amide (e.g., dimethylformamide), ester (e.g., methyl acetate or ethyl acetate), ether (e.g., tetrahydrofuran), carbonate (e.g., propylene carbonate), chlorohydrocarbon (e.g., methylene chloride), or nitrile (e.g., acetonitrile). In some embodiments, one or more classes or specific types of any of the above plasticizers are excluded from the precursor material. In some embodiments, the plasticizer or other auxiliary component may be removed from the extrudate by subjecting the extrudate to a post-bake process that employs a suitably high temperature capable of volatilizing the plasticizer or other auxiliary component.

Other (auxiliary) components may be included in the precursor material in order to favorably affect the physical or other properties of the precursor material or the final bonded magnet. For example, an electrical conductivity enhancing agent, such as conductive carbon particles, may be included to provide a desired level of conductivity, if so desired. To suitably increase the rigidity of the extruded or final magnetic composite, a hardening agent, such as a crosslinking agent, curing agent, or a filler (e.g., talc), may or may not be included. To improve or otherwise modify the interfacial interaction between the magnetic particles or auxiliary particles and polymeric binder, a surfactant or other interfacial agent may or may not be included. To impart a desired color to the final composite fiber, a coloring agent may also be included. In other embodiments, one or more classes or specific types of any the above additional components may be excluded from the precursor material.

In the method described herein, the reactive precursor material containing the polymeric components and magnetic particles is mixed and incorporated into an additive manufacturing device (AMD), or individual components of the reactive precursor material are separately incorporated into the AMD and then mixed within the AMD. In order to avoid a temperature that could denature the magnetic particles, the precursor material is preferably not heated, or may be controlled to be within a temperature of no more than 30° C., 40° C., or 50° C. within the AMD and after deposition onto a substrate. As the reaction between amine and isocyanate components is generally exothermic, heat is generally not applied. Cooling means may be included to maintain the temperature within an acceptable temperature range.

The precursor material is extruded through a nozzle of the additive manufacturing device. As the extrudate exits the nozzle and is deposited, the extrudate cools as the amine and isocyanate components continue reacting, which results in an increase in viscosity and a transition of the extrudate to a solidified preform. The solidified preform, as initially deposited, is resilient enough to resist deformation upon deposition of subsequent layers of extrudate. At the same time as successive layers are deposited, the earlier deposited solidified layer has not fully cured, which permits reactive bonding between layers of extrudate over the period of time in which the object is being built. After the extrudate is deposited, the solidified preform is exposed to conditions where the solidified preform is permitted to fully cure. Typically, the conditions include simply permitting the solidified preform to cool to ambient temperature and dwell at the ambient temperature over a period of time. During the curing stage, the viscosity of the solidified preform substantially increases, generally to a value above 100,000 cPs, and typically, a viscosity of at least or above 200,000, 500,000, or 1,000,000 cPs (where cPs is centipoise), and eventually, a transition to a completely non-flowable solid that may be characterized by the usual properties of a solid, e.g., tensile strength and elasticity. The period of time over which the solidified preform completely cures is generally at least 30 minutes. In different embodiments, the curing time is at least 30, 60, 90, 120, 150, or 180 minutes, or a curing time within a range bounded by any two of the foregoing values.

In some embodiments, as the extrudate exits the nozzle and is deposited as a solidified preform, the extrudate is exposed to a directional (external and non-varying) magnetic field of sufficient strength to align the magnetic particles. The alignment of the magnetic particles refers to at least an alignment of the individual magnetic fields (or poles) of the magnetic particles. In the case of anisotropically shaped magnetic particles, the alignment also involves a physical alignment, e.g., axial alignment of filamentous particles. The polyurea polymer may also undergo alignment, particularly if the polyurea polymer includes an aromatic component. As the magnetic particles and/or polyurea polymer require an appreciable degree of freedom of movement to align themselves, the exposure to the directional magnetic field should occur at least during the time the precursor material has not completely cured. Generally, in order for magnetic particles and/or the polyurea polymer to sufficiently re-orient and align in the melt, the melt should possess a melt viscosity of up to or less than 20,000, 50,000, or 100,000 cPs. However, in order to ensure that the extrudate maintains a shape when deposited, the extrudate should have a viscosity of at least 1,000, 2,000, 5,000, or 10,000 cPs when subjected to the magnetic field. In order to sufficiently align the magnetic particles and/or polyurea polymer, the external magnetic field should generally have a magnetic field strength of at least 0.25 or 0.5 Tesla (0.25 or 0.5 T). In different embodiments, the external magnetic field has a magnetic field strength of about, at least, above, up to, or less than, for example, 0.5, 1, 1.2. 1.5, 2, 2.5, 3, 3.5, 4, 5, 6, 7 or 8 T.

Examples have been set forth below for the purpose of illustration and to describe certain specific embodiments of the invention. However, the scope of this invention is not to be in any way limited by the examples set forth herein.

### EXAMPLES

### Example 1. Preparation and Analysis of Polyurea-Based Polymer Systems

Multi-component poly(urea)-based systems for direct print additive manufacturing were determined to be feasible and in some aspects superior to traditional polymer additive manufacturing. The reaction kinetics and transient rheological properties are tunable via slight modifications in chemistry and/or thermal profiles after mixing the amine and isocyanate based components. Four amines and four isocyanates of varying viscosity and reactivity were studied. The identities of the amines and isocyanates and their properties are provided in Tables 1 and 2 below, respectively. The reaction kinetics, flow profile, and printability of various component mixtures and mechanical properties of cast neat and reinforced additively manufactured parts using these amines and isocyanates were studied.

TABLE 1
Precursor Amine Compounds

| | | | | Relative |
|---|---|---|---|---|
| Trade | Desig- | Equiv. | | reactivity |
| NAME | nation | Weight | Viscosity | 1 = highest |
| NH 1220 | A | 229 | 150 cps @ 25° C. | 1 |
| NH 1420 | B | 277 | 1000-1500 cps @ 25° C. | 2 |
| NH 1520 | C | 291 | 1500 cps @ 25 C. | 3 |
| Jefflink 754 | D | 128 | 8 cST @ 40° C. | 2 |

TABLE 2
Precursor Isocyanate Compounds

| | | Equiv. | | Relative |
|---|---|---|---|---|
| Trade NAME | Designation | Weight | Viscosity | Reactivity |
| XP2580 | 1 | 217 | 440 cps @ 25° C. | 1 |
| XP2410 | 2 | 175 | 600 cps @ RT | 1 |
| HDI | 3 | 84 | 3 cps @ 25 C. | 1 |
| IPDI | 4 | 111 | 14 cps @ 25 C. | 2 |

The following viscosities of common fluids and polymers are also provided for reference: Water=0.894 cPs; Olive Oil=81 cPs; Glycerol=1,200 cPs; Honey=2,000-10,000 cPs; ABS above Tₘ=155,000-1,550,000 cPs.

Amines A, B, C, and D are commercially available and have the following structures:

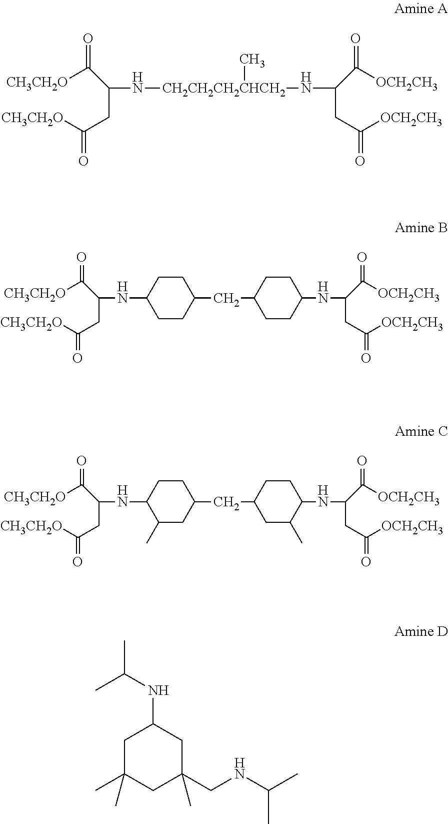

The four listed isocyanates (1, 2, 3, and 4 in Table 2) are commercially available. XP2580 and XP2410 refer to Desmodur® XP2580 and Desmodur® XP2410, are aliphatic isocyanates. XP2410 contains an isocyanurate moiety, as described above, and is based on hexamethylene diisocyanate. The identity of HDI and IPDI have been provided above.

The reaction kinetics were examined using optical transmission-based stopped flow reaction kinetics analytical methods. This method essentially consists of injecting the reactants from two independent syringes into a small reaction vessel and monitoring UV-Vis absorption at a characteristic wavelength. Rapid mixing and injection of the polymer into the cuvette minimized the dead time before data acquisition. The polymerization reaction results in the formation of amide bonds, which give rise to characteristic absorption peaks. Changes in absorption as a function of time were recorded to capture initial rates and the steady-state level of polymerization. Characterization of polymerization kinetics allows for investigation of the reaction mechanism and evaluation of the rate constants. The ephemeral optical transmission/reflection of the reacting solution was analyzed to determine the fast portion of the reaction kinetics. This information, combined with thermodynamic and mechanical characterization techniques, allows for targeted design of reactive polymer formulations optimized for additive manufacturing applications.

Kinetic data was interpreted in terms of a model of the polymerization process with kinetic constants valid in the context of that model. A set of differential equations could be used to describe the kinetic model. Non-linear least squares analysis of the experimental data was employed to obtain best fit values for the rate constants defined by the model equations. This data could be used to determine the method and feasibility of extrusion based deposition system along with the predicted deposition rates. For faster setting polymers, the kinetics were measured by using a thermocouple attached to a stirring rod to measure the change in temperature caused by the exothermic reaction.

Reaction Kinetics

For the reaction kinetics experiment, isocyanates and amines were mixed in a beaker based on the optimum mixing ratios. A drop of the mixture was placed between two quartz slides, which were taped around the edges and placed into a spectrophotometer. The UV absorption was observed while the sample cured. The change in the absorption over time was used as an indicator of the reaction progress, and was used to estimate the reaction speed and time as well as observe how the reaction speed changes over time. Polymers made using amines A and D cured too quickly to be measured using the spectrophotometer. For those polymers, the reaction kinetics were measured by observing the change in temperature produced during the exothermic reaction. The recorded reaction times or curing times of different amine-isocyanate systems are provided in Table 3 below. Note: the term “A1” indicates presence (combination) of amine A and isocyanate 1; likewise, the term “A2” indicates presence (combination) of amine A and isocyanate 2, wherein amines A, B, C, and D and isocyanates 1, 2, 3, and 4 have been identified above.

TABLE 3
Reaction kinetics of different amine-isocyanate systems

| Combination | Reaction Time (s) | Combination | Curing Time (min) |
|---|---|---|---|
| A1 | 48 | B1 | 45 |
| A2 | 46 | B2 | 10 |
| A3 | 27 | B3 | 17 |
| A4 | 24 | B4 | 9 |
| D1 | 17 | C1 | 30 |
| D2 | 10 | C2 | 500 |
| D3 | 10 | C3 | [symbol] 500 |
| D4 | 9 | C4 | [symbol] 500 |

From the above experiments, it was unexpectedly found that the amine used has a significantly greater effect on the reaction kinetics than the isocyanate. The reaction speed, in order from fastest to slowest, was as follows: amines D, A, B, C. The isocyanates had a minor effect on the kinetics, with the order from fastest to slowest being 4, 3, 2, 1.

Drop Flow Test

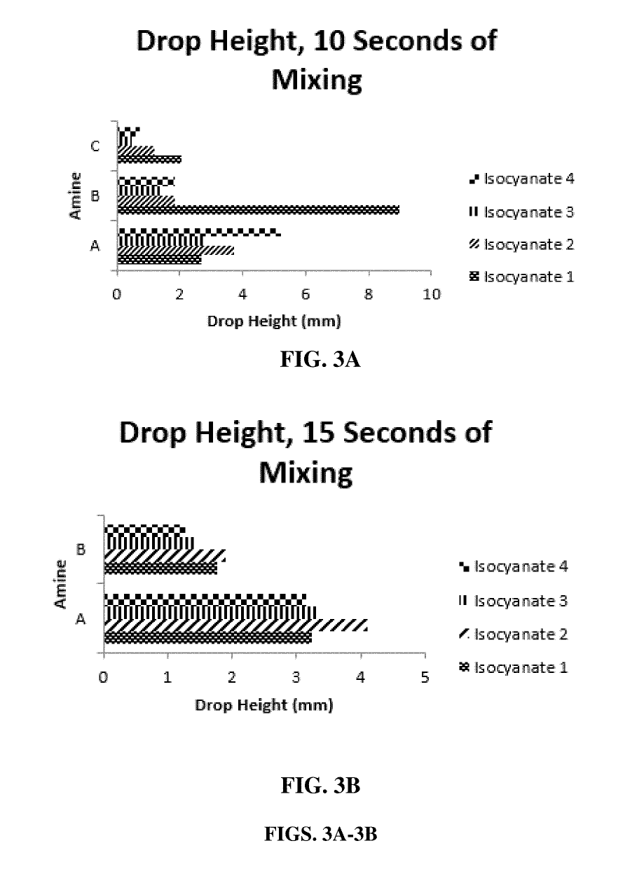

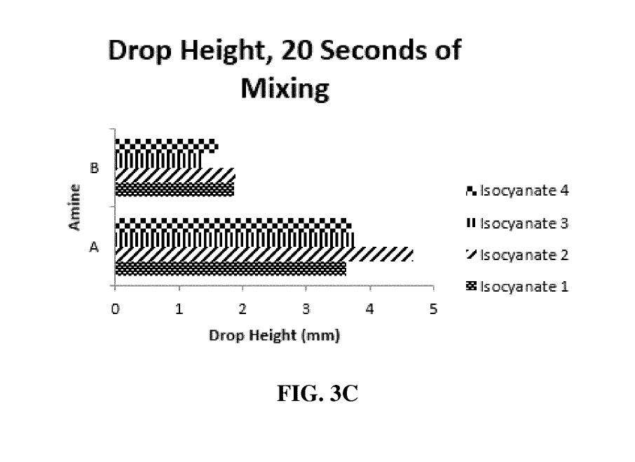

This simple test consists of depositing the reactive polymer mixture at a constant rate onto a flat room-temperature or heated surface for a predefined time interval. The height, width, and morphology of the “drop” are used to characterize the material's ability to form free-standing structures. FIGS. 3A, 3B, and 3C show the results of the drop test in graph format for drop heights of 10, 15, and 20 seconds of mixing, respectively.

The results from the drop test, as shown in FIGS. 3A, 3B, and 3C, show that the fastest reacting amines, A and D, are the most promising for additive manufacturing at room temperature. They both cure quickly enough that a second layer can be deposited without the need for a long cure time and are spatially locked after deposition, thus requiring less setting time between layers and enabling higher throughput. Amines B and C produce polymers that take a substantially longer time to cure and spread too thinly for use in additive manufacturing, at least under the conditions employed in this experiment. Mixtures using amine A showed the most promise in the drop test for additive manufacturing using lower deposition rates. Mixtures using amine D set to a point where they would not flow after just a few seconds of mixing. Because of this, a drop test was not able to be performed using amine D as the sample would set to the point where it would not pour before complete mixing could be achieved. This high cure rate means that, while amine D would not work well for lower flow rate applications, it has potential to work in high-speed, high-volume processes using a high deposition rate.

Demonstration of High Throughput Additive Manufacturing

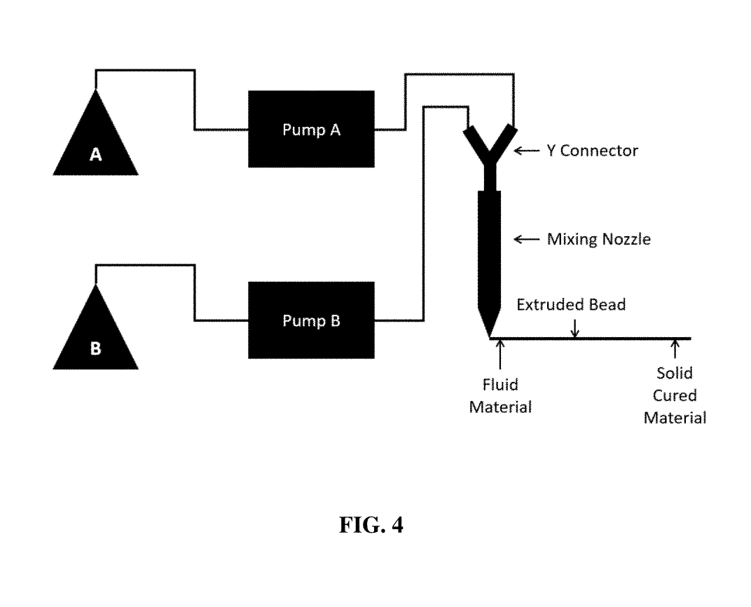

FIG. 4 is a drawing of a set-up for a bead-forming experiment used for simulating an additive manufacturing process. For the bead-forming experiment, peristaltic pumps were used in order to control the flow rate of the isocyanates and amines. The mixed polymer was extruded onto a flat surface, simulating what would happen in an additive manufacturing system. From these experiments, it was determined that the mixed polymers were not viscous enough to form a bead in pure form and did not pump evenly due to the differing viscosities of the various components. Several additives, including carbon nanotubes, Cloisite 15A nanoclay, and Cab-O-Sil TS-720 fumed silica, were then used to increase the viscosity of the individual components to a gel-like consistency prior to pumping and mixing

### Example 2. Bonded Permanent Magnet Fabrication

Polymer bonded magnets were produced by extrusion using commercial anisotropic magnet powder (Magnequench™ MQA) mixed with B2, C2, and C4 isocyanate-amine combinations. The initial magnetic properties of the MQA powder was determined with a SQUID magnetometer. The as-received MQA powder has an intrinsic coercivity (H_{ci}) of 12 kOe and a remanence (Mᵣ) of 12.9 kG. The powder was rated for a (BH)ₘₐₓ of 38 MGOe. Different vol % (30, 40, 60, and 65) of MQA powders were mixed with C4 isocyanate-amine polymer mixtures using a magnetic stirrer. Unaligned bonded magnet samples were aligned in a field of 9 T overnight. C4 polymers cross-linked and cured while the magnet powders were aligned. Magnetization was measured for each sample at constant applied magnetic field. Similarly, 40 vol % MQA powders were mixed with B2 and C2 isocyanate-amine polymer mixtures and aligned in a magnetic field. Curing times for each of the poly(urea)-NdFeB bonded magnets are reported in Table 3 above.

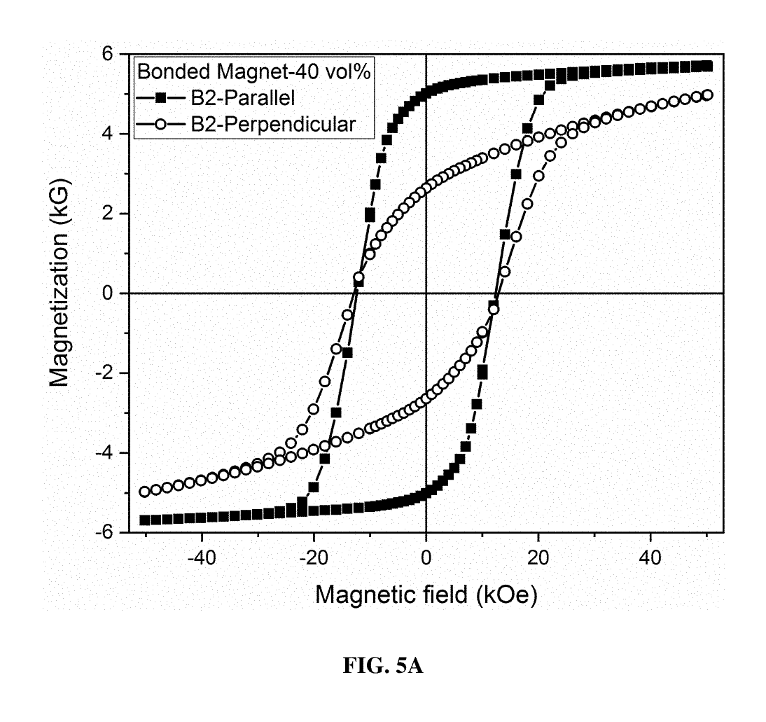

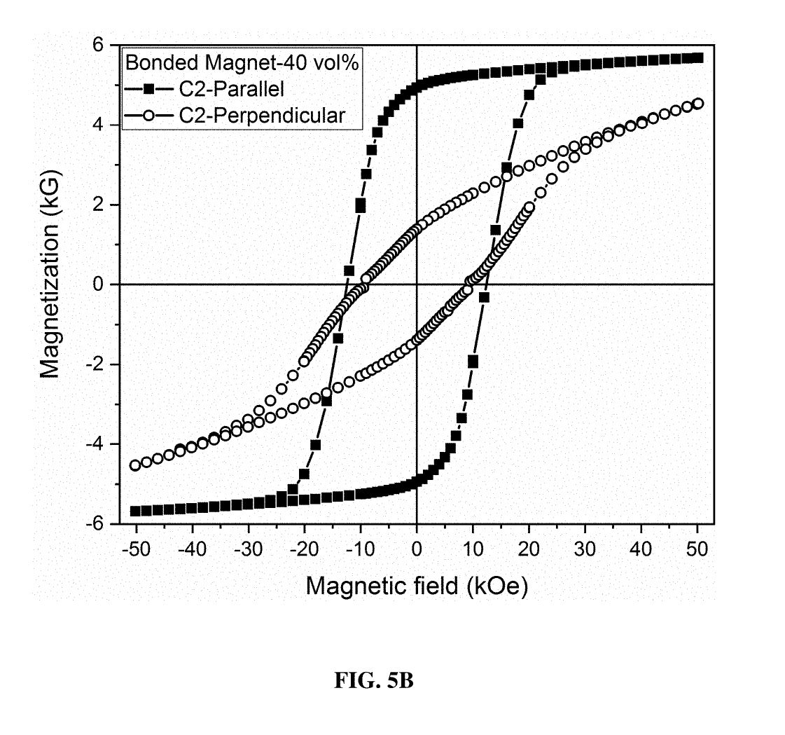

FIGS. 5A and 5B show magnetic hysteresis loops of the bonded magnet samples using B2 and C2 compositions, respectively. The hysteresis loops for B2 and C2 magnets are comparable. In addition, anisotropy was maintained as observed from the parallel vs. perpendicular measurements in each of FIGS. 5A and 5B. Notably, the perpendicular C2 sample was misaligned during the measurement.

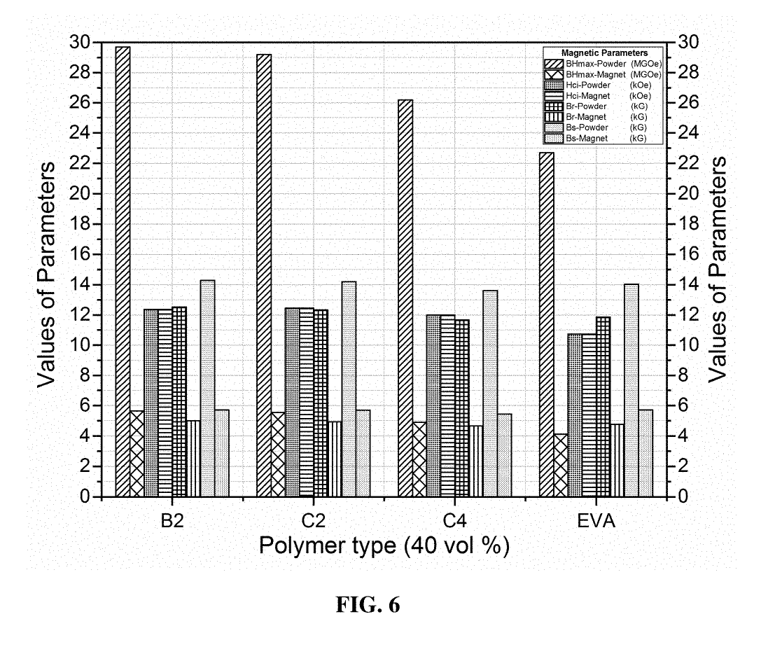

The magnetic properties of B2, C2, C4 isocyanate-amine polymer matrices, and separately, ethyl vinyl acetate (EVA) polymer matrix, all loaded with 40 vol % MQA powder, are shown in FIG. 6. The magnetic parameters extracted from the hysteresis loops are comparable for the B2 and C2 bonded magnets. B2 and C2 show improvement compared with other polymers studied (at 40 vol % loading fraction). Similarly, D- and A-type isocyanate-amine polymer mixtures can be used to align MQA powders and align in a magnetic field. These results provide evidence that anisotropic MQA NdFeB powders in B2 and C2 polymers can be aligned by either pre-aligning or during printing to achieve high energy product magnet samples.

While there have been shown and described what are at present considered the preferred embodiments of the invention, those skilled in the art may make various changes and modifications which remain within the scope of the invention defined by the appended claims.

What is claimed is:

1. A method for producing a bonded permanent magnet by additive manufacturing, the method comprising:
(i) incorporating components of a reactive precursor material into an additive manufacturing device, the reactive precursor material comprising an amine component, an isocyanate component, and particles having a permanent magnetic composition; and
(ii) mixing and extruding said reactive precursor material through a nozzle of said additive manufacturing device and depositing the extrudate onto a substrate under conditions where the extrudate is permitted to cure, to produce a bonded permanent magnet of desired shape;
wherein said amine component comprises an amine-containing molecule selected from at least one of the following structures: 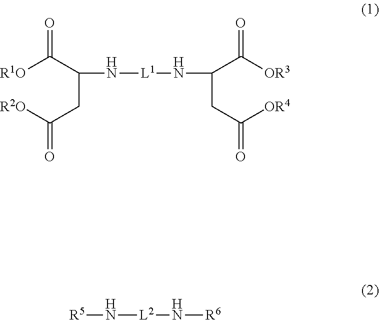
wherein:
L¹ is a straight-chained or branched alkyl linker containing at least four and up to twelve carbon atoms;
R¹, R², R³, and R⁴ are selected from straight-chained or branched alkyl or alkenyl groups containing one to three carbon atoms, and saturated or unsaturated cyclic hydrocarbon groups;
L² is a linker containing at least one saturated carbocyclic ring; and
R⁵ and R⁶ are selected from straight-chained or branched alkyl or alkenyl groups containing three to eight carbon atoms, and saturated or unsaturated cyclic hydrocarbon groups.

2. The method of claim 1, wherein said amine component comprises an amine-containing molecule according to Formula (1).

3. The method of claim 2, wherein said amine-containing molecule according to Formula (1) has the following structure:

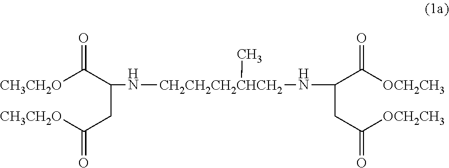

4. The method of claim 1, wherein said amine component comprises an amine-containing molecule according to Formula (2).

5. The method of claim 4, wherein said amine-containing molecule according to Formula (2) has the following structure:

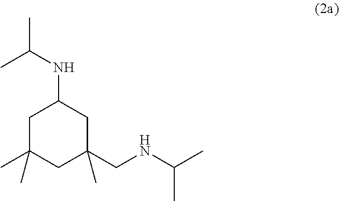 [SMILES: CC(C)NCC1(C)CC(NC(C)C)CC(C)(C)C1]

6. The method of claim 1, wherein, as the extrudate exits from the nozzle and is deposited on a substrate, the extrudate is exposed to a directional magnetic field of sufficient strength to align the particles having a permanent magnetic composition.

7. The method of claim 1, wherein, after depositing said extrudate onto said substrate, the extrudate continues to undergo amine-isocyanate crosslinking over at least thirty minutes.

8. The method of claim 1, wherein said permanent magnetic composition comprises at least one element selected from iron, cobalt, nickel, copper, gallium, and rare earth elements.

9. The method of claim 1, wherein said permanent magnetic composition has a rare earth composition.

10. The method of claim 9, wherein said permanent magnetic composition has a samarium-containing, neodymium-containing, or praseodymium-containing composition.

11. The method of claim 1, wherein said reactive precursor material further comprises a non-magnetic solid filler material that increases the viscosity of the reactive precursor material.

12. The method of claim 11, wherein said non-magnetic solid filler material comprises carbon particles.

13. The method of claim 12, wherein said carbon particles are carbon nanotubes.

14. The method of claim 11, wherein said non-magnetic solid filler material comprises metal oxide particles.

15. The method of claim 14, wherein said metal oxide particles are selected from clay and silica particles.

16. The method of claim 1, wherein said isocyanate component is an aliphatic isocyanate.

17. The method of claim 16, wherein said aliphatic isocyanate is HDI or IPDI.

18. The method of claim 1, wherein said isocyanate component is an aromatic isocyanate.

19. The method of claim 18, wherein said aromatic isocyanate is TDI or MDI.

20. The method of claim 1, wherein said isocyanate component comprises at least one isocyanate-containing molecule containing an isocyanurate ring.

21. The method of claim 20, wherein said isocyanate-containing molecule has the following structure: 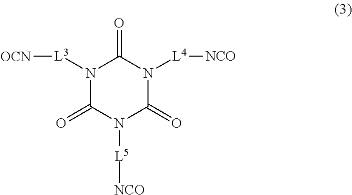
wherein L³, L⁴, and L⁵ are selected from straight-chained, branched, and cyclic alkyl linkers containing at least four and up to twelve carbon atoms.

22. The method of claim 1, wherein said particles having a permanent magnetic composition are included in an amount of at least 50 wt. % in said reactive precursor material.

23. The method of claim 1, wherein said particles having a permanent magnetic composition are included in an amount of at least 60 wt. % in said reactive precursor material.
